(19) United States
(12) Patent Application Publication
(10) Pub. No.: US 2011/0308159 A1
(43) Pub. Date: Dec. 22, 2011

(54) Apparatus for detecting coordinates, and display device, security device, and electronic blackboard including the same

(75) Inventors: Jae Kwang Lee, Seongnam (KR); Victor Yurlov, Suwon (KR); Won Tae Choi, Hwaseong (KR); Hyun Jun Kim, Suwon (KR); Jin Yong Kang, Hwaseong (KR)

(73) Assignee: SAMSUNG ELECTRO-MECHANICS CO., LTD., Suwon (KR)

(21) Appl. No.: 13/067,678

(22) Filed: Jun. 20, 2011

(30) Foreign Application Priority Data
Jun. 22, 2010 (KR) 10-2010-0059181

(51) Int. Cl. E05F 15/20; G06F 3/042

(52) U.S. Cl. 49/25; 345/175

(57) ABSTRACT

There are provided an apparatus for detecting coordinates, which may detect coordinates corresponding to an event occurring within a region of interest, and a display device, a security device, and an electronic blackboard, each including the same. The apparatus for detecting coordinates, which is provided in at least one side of a touch panel having a preset region of interest being surrounded by a frame having a predetermined length, the apparatus comprising: a light source body providing preset light; a scanner emitting the light provided from the light source body at a preset angle to scan the region of interest, and receiving light reflected by the region of interest; a photo diode receiving reflected light to convert the received reflected light to a voltage value; and a beam splitter transmitting the light provided from the light source body to the scanner via a first path, and transmitting, to the photo diode via a second path, the reflected light received from the scanner.

### CROSS-REFERENCE TO RELATED APPLICATIONS

This application claims the priority of Korean Patent Application No. 10-2010-0059181 filed on Jun. 22, 2010, in the Korean Intellectual Property Office, the disclosure of which is incorporated herein by reference.

### BACKGROUND OF THE INVENTION

1. Field of the Invention

The present invention relates to an apparatus for detecting coordinates, which may detect coordinates corresponding to an event occurring within a region of interest, and to a display device, a security device, and an electronic blackboard, each including the same.

2. Description of the Related Art

An apparatus in which a change generated in a region of interest may be sensed in order to obtain coordinates is widely utilized.

As a method for detecting the coordinates of a location in which a touch is performed in a display panel, being a region of interest of a mobile communication terminal such as a mobile phone, a personal digital assistant (PDA), a notebook, and the like, an ultrasound scheme, an infrared scheme, a resistive scheme, a capacitive scheme, or the like may be used. Recently, the capacitive scheme has been increasingly used.

Meanwhile, in the case that the display panel being the region of interest has a large size, a method of detecting the coordinates of an event using an imaging device, for example, a camera, may be suggested.

Here, the event may be an operation or a condition generated in the region of interest, for example, a touch operation, and may be defined as a change in an image occurring in an image sensor of the imaging device.

A conventional apparatus for detecting the coordinates of an event occurring within the region of interest may include at least two divided imaging devices for receiving image information of the event occurring within the region of interest, and an imaging processing unit for processing the received image information.

When the at least two divided imaging devices are installed to face the region of interest, a significant installation space may be disadvantageously required.

Also, since information obtained from the divided imaging devices may be transmitted to the imaging processing unit to be integrated, synchronization may need to be matched at the time of processing.

### SUMMARY OF THE INVENTION

An aspect of the present invention provides an apparatus for detecting the coordinates of an event occurring within a region of interest, which is capable of processing information about the event using at least one module.

An aspect of the present invention also provides a display device, a security device, and an electronic blackboard, each including the apparatus for detecting the coordinates of the event occurring within the region of interest.

According to an aspect of the present invention, there is provided an apparatus for detecting coordinates, which is provided in at least one side of a touch panel having a preset region of interest being surrounded by a frame having a predetermined length, the apparatus including: a light source body providing preset light; a scanner emitting the light provided from the light source body at a preset angle to scan the region of interest, and receiving light reflected by the region of interest; a photo diode receiving reflected light to convert the received reflected light to a voltage value; and a beam splitter transmitting the light provided from the light source body to the scanner via a first path, and transmitting, to the photo diode via a second path, the reflected light received from the scanner.

The apparatus may further include a control unit controlling the light source body to be emitted in a preset time unit, and calculating a location of an event occurring within the region of interest using a light emitting angle of the scanner and a time difference between emitted light and reflected and received light.

The apparatus may further include a power supplying unit supplying, to the light source body, a pulse of power in the preset time unit based on a control of the control unit.

The apparatus may further include a lens condensing the reflected light received from the beam splitter.

The scanner may scan the region of interest by being rotated in a preset angle unit from a reference surface of the region of interest, based on a control of the control unit.

The light source body may emit infrared light.

According to another aspect of the present invention, there is provided a display device, including: a display panel being a region of interest; a support frame supporting the display panel; and an apparatus for detecting coordinates disposed in a side of the support frame, the apparatus including a light source body providing preset light to the display panel, a scanner emitting the light provided from the light source body at a preset angle to scan the region of interest of the display panel and receiving light reflected by the region of interest, a beam splitter transmitting the light provided from the light source body to the scanner via a first path and transmitting, to a second path different from the first path, the reflected light received from the scanner, and a photo diode receiving the reflected light received from the beam splitter to convert the received reflected light to a voltage value.

The apparatus may further include a control unit controlling the light source body to be emitted in a preset time unit, and calculating a location of an event occurring within the region of interest using a light emitting angle of the scanner and a time difference between emitted light and reflected and received light.

The apparatus may further include a power supplying unit supplying, to the light source body, a pulse of power in the preset time unit based on a control of the control unit, and a lens condensing the reflected light received from the beam splitter.

The support frame may include an inner side surface formed along edges of the display panel, the inner side surface facing the display panel, and a reflecting surface reflecting light from the apparatus for detecting coordinates or an absorbing surface absorbing the light from the apparatus for detecting coordinates may be formed in the inner side surface.

According to another aspect of the present invention, there is provided a security device, including: an apparatus for detecting coordinates including a light source body providing preset light to a door being a region of interest, a scanner emitting the light provided from the light source body at a preset angle to scan the region of interest and receiving light reflected by the region of interest, a beam splitter transmitting the light provided from the light source body to the scanner via a first path and transmitting, to a second path different from the first path, the reflected light received from the scanner, and a photo diode receiving the reflected light received from the beam splitter to convert the received reflected light to a voltage value; and a control unit controlling opening and closing of the door by wiredly or wirelessly receiving event information obtained from the apparatus for detecting coordinates.

The control unit may further control the light source body to be emitted in a preset time unit, and calculate a location of an event occurring within the region of interest using a light emitting angle of the scanner and a time difference between emitted light and reflected and received light.

According to another aspect of the present invention, there is provided an electronic blackboard, including: a display board being a region of interest and displaying a trajectory of an event occurring within the region of interest; and an apparatus for detecting coordinates including a light source body providing preset light, a scanner emitting the light provided from the light source body at a preset angle to scan the region of interest of the display board and receiving reflected light by the region of interest, a beam splitter transmitting the light provided from the light source body to the scanner via a first path and transmitting, to a second path different from the first path, the reflected light received from the scanner, and a photo diode receiving the reflected light received from the beam splitter to convert the received reflected light to a voltage value, the apparatus for detecting coordinates detecting the coordinates of a trajectory of an event occurring within the region of interest.

The electronic blackboard may further include a control unit wiredly or wirelessly receiving information about the event of the apparatus for detecting coordinates.

The control unit may control the light source body to be emitted in a preset time unit, and calculate a location of the event occurring within the region of interest using a light emitting angle of the scanner and a time difference between emitted light and reflected and received light.

The electronic blackboard may further include a support frame supporting the display board, wherein the support frame may include an inner side surface formed along edges of the display board, the inner side surface facing the display board, and a reflecting surface reflecting light provided from the apparatus for detecting coordinates or an absorbing surface absorbing the light provided from the apparatus for detecting coordinates may be formed in the inner side surface.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view used for describing a principle of an apparatus for detecting coordinates according to an exemplary embodiment of the present invention;

FIG. 2 is an enlarged view of “A” of FIG. 1;

FIG. 3 is a schematic view used for describing coordinate-calculation of an apparatus for detecting coordinates according to an exemplary embodiment of the present invention;

FIG. 4 is a schematic perspective view showing a display device to which an apparatus for detecting coordinates is applied according to an exemplary embodiment of the present invention;

FIG. 5 is a schematic perspective view showing the display device of FIG. 4 according to another exemplary embodiment of the present invention;

FIG. 6 is a schematic perspective view showing a security device to which an apparatus for detecting coordinates is applied according to an exemplary embodiment of the present invention; and

FIG. 7 is a schematic perspective view showing an electronic blackboard to which an apparatus for detecting coordinates according to an exemplary embodiment of the present invention is applied.

### DETAILED DESCRIPTION OF THE PREFERRED EMBODIMENT

Exemplary embodiments of the present invention will now be described in detail with reference to the accompanying drawings.

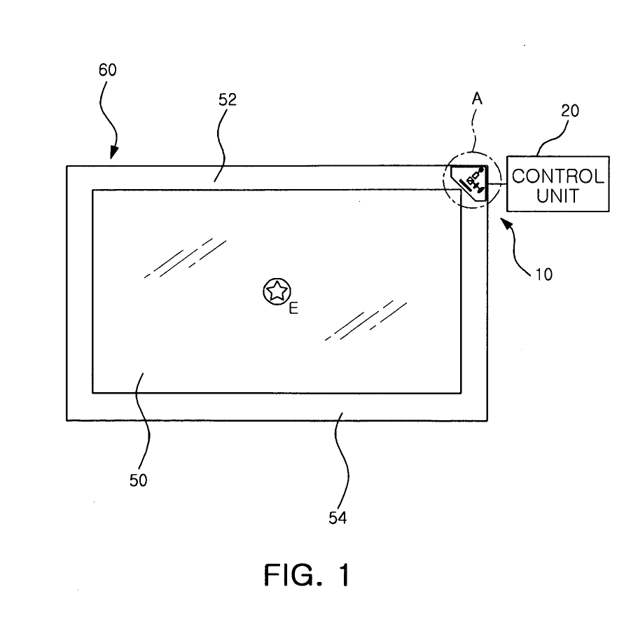

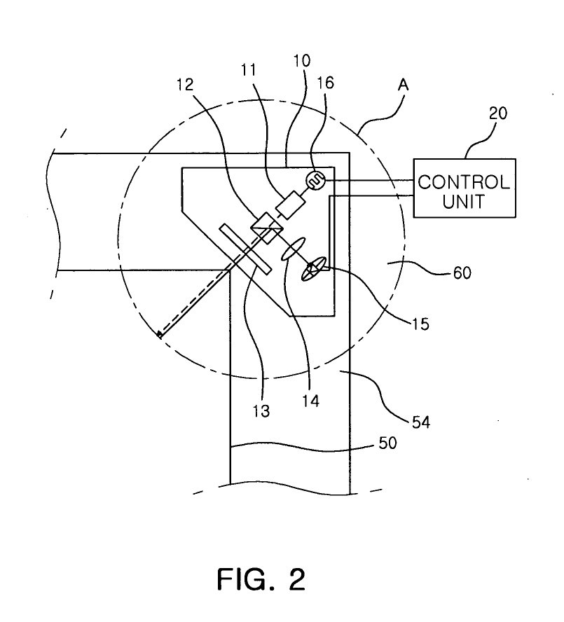

FIG. 1 is a schematic view used for describing a principle of an apparatus for detecting coordinates according to an exemplary embodiment of the present invention, and FIG. 2 is an enlarged view of “A” of FIG. 1.

Referring to FIGS. 1 and 2, the apparatus 10 for detecting coordinates according to the present exemplary embodiment may include a light source body 11, a beam splitter 12, a scanner 13, a lens 14, a photo diode 15, and a power supplying unit 16.

Light provided from the light source body 11 may be transmitted to the scanner 13, and the scanner 13 may emit the transmitted light at a preset angle to scan a region 50 of interest of the apparatus 10. The region 50 of interest may be a region used by the apparatus 10 for obtaining coordinates, and an arbitrary two-dimensional (2D) plane may be broadly a target of the region 50 of interest.

The apparatus 10 may be mounted on an edge of a side of the region 50 of interest.

The light source body 11 may be formed of an infrared light emitting body, and a plurality of light source bodies 11 may be provided based on a size of the region 50 of interest, or provided to increase a life span of a light source. The light transmitted from the light source body 11 may be radially scanned through the scanner 13 to scan the region 50 of interest. Accordingly, the scanner 13 may scan the region 50 of interest by injecting light while being rotated at a preset angle from a reference surface of the region 50 of interest. In addition, the light source body 11 may emit light in a preset time unit. For this, the apparatus 10 may further include the power supplying unit 16 for supplying a pulse of power to the light source body 11.

In FIG. 1, the region 50 of interest formed to have a rectangular shape is illustrated, however, the region 50 of interest may be provided having various shapes, depending on a disposed position, and the like, of the light source body 11 within the apparatus 10. Here, a boundary of the region 50 of interest may be formed of a support frame supporting the region 50 of interest, which may be represented as a reference numeral 52, a region of the support frame 52 in which the apparatus 10 is installed may be represented as a reference numeral 54, and a touch panel including the support frame 52 supporting the region 50 of interest may be represented as a reference numeral 60.

When an event (E) occurs in the region 50 of interest, reflected and received light may be transmitted to the apparatus 10. Here, the event (E) may be defined as an operation or a condition being a target of which coordinates are intended to be measured by the apparatus 10.

The received light may be transmitted to the beam splitter 12 through the scanner 13 of the apparatus 10, and the beam splitter 12 may transmit the received light via a second path different from a first path via which the light provided from the light source body 11 is transmitted to the scanner 13.

The lens 14 may condense the light transmitted from the beam splitter 12, and the photo diode 15 may convert, to a voltage value, the light condensed from the lens 14.

The apparatus 10 may include a control unit 20 formed therein that may receive the voltage value from the photo diode 15 to thereby process data. Meanwhile, the control unit 20 may be formed of a separate module outside the apparatus 10. When the control unit 20 is formed of the separated module outside the apparatus 10, a voltage value of light reflected by the occurring event (E) may be received in a wired or wireless communication manner. The control unit 20 may control the power supplying unit 16 to supply a pulse of power to the light source body 11 in a preset time unit.

Hereinafter, a method for obtaining the coordinates of an event (E) when the event (E), a contact operation for example, occurs within the region 50 of interest, will be described in detail.

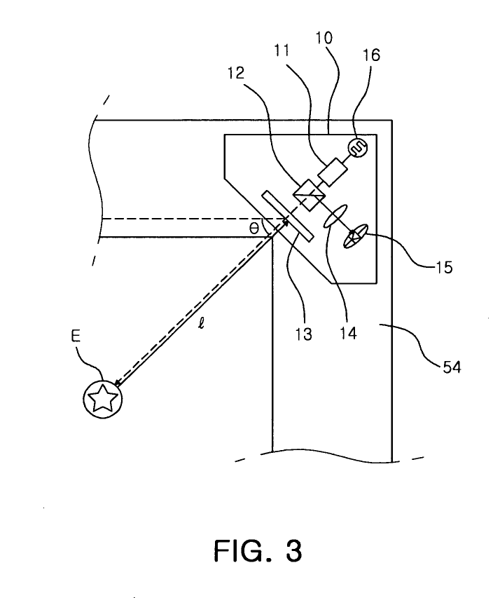

FIG. 3 is a schematic view used for describing coordinate-calculation of an apparatus for detecting coordinates according to an exemplary embodiment of the present invention.

Referring to FIG. 3, when an event (E), for example, a touch operation of a user occurs in the region 50 of interest, infrared light emitted from the apparatus 10 may be reflected by the event (E) to be repeatedly transmitted to the apparatus 10.

In FIG. 3, an angle between each of light emitted from the scanner 13 and reflected light of an event (E) with the reference surface of the region 50 of interest may be represented as ‘θ’, and a length from the event (E) to the scanner 13 may be represented as ‘l’.

The control unit 20 may set a unit time when the light source body 11 is emitted, and may control such that the scanner 13 emits light to the region 50 of interest for each unit time when the light source body 11 is emitted, to thereby scan the region 50 of interest while being rotated at a preset angle. Accordingly, the angle between each of the light emitted from the scanner 13 and the reflected light of the event (E) with the reference surface of the region 50 of interest may be obtained. Also, the control unit 20 may receive reflected light of light emitted at a current unit time between the current unit time when the light source body 11 is emitted and a next unit time when the light source body 11 is emitted immediately following the current unit time. Accordingly, when the reflected light is in a preset time range, the control unit 20 may recognize that the event does not occur, and when the reflected light is shorter than a preset period, the control unit 20 may recognize that the event occurs, so that a distance by which the event occurs may be obtained by a time difference between a time when light is emitted and a time when reflected light is received. In this instance, when a voltage value of the reflected light is less than or equal to a preset reference value, the reflected light may be recognized as reflected light of light having been previously emitted, thereby suppressing location arithmetic errors.

The control unit 20 may detect coordinates at which the event (E) occurs within the region 50 of interest of a two-dimensional (2D) plane by the above described angle and distance.

In addition, when the event (E) is moved, since relative coordinates of a new event (E′) may be obtained, the apparatus 10 may acquire information about the event (E) changed in real time, such as movement, drag, appearance, disappearance, and the like of the event (E).

Hereinafter, various exemplary embodiments of the present invention to which the apparatus 10 for detecting coordinates is applied will be described in detail. Here, only a display device 100, a security device 200, and an electronic blackboard 300 to which the apparatus 10 is applied will be described, however, the apparatus 10 may be applied to any device in which coordinates need to be detected.

In addition, the apparatus 10 applied herein may have the same technical features as those of the apparatus 10 described with reference to FIGS. 1 to 3, and thus further descriptions thereof will be omitted.

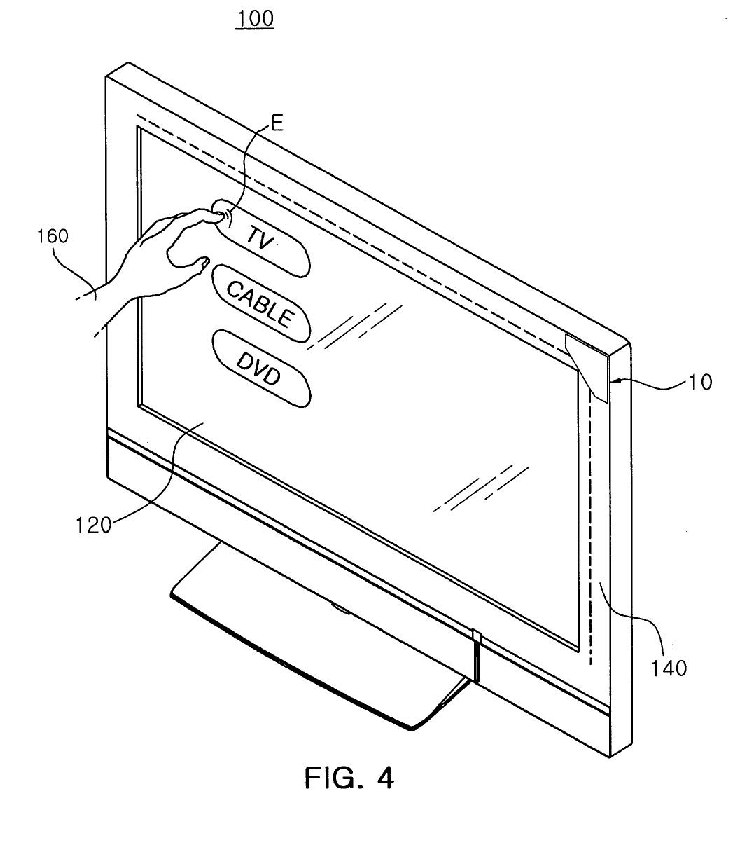

FIG. 4 is a schematic perspective view showing a display device to which an apparatus for detecting coordinates is applied according to an exemplary embodiment of the present invention.

Referring to FIG. 4, the display device 100 may include a display panel 120, a support frame 140, and the apparatus 10 for detecting coordinates.

Here, the display device 100 may be a term including all display devices, and a plasma display panel (PDP), a liquid crystal display (LCD), an organic light emitting diode (OLED), an active matrix organic light emitting diode (AMORED), and the like may be used as the display device 100.

The display panel 120 may be a region of interest of the apparatus 10. Various user interfaces (UIs) may be provided to the display panel 120. Here, by means of an indicating means for the UI, an event (E), for example, a touch operation may occur. Here, a finger 160 may be illustrated as the indicating means for the UI; however, the indicating means may denote all means capable of pressing the UI, such as a pen, and the like.

Coordinate information of the event (E) may be obtained by the apparatus 10 disposed in a side of the support frame 140. The apparatus 10 may be included in the support frame 140.

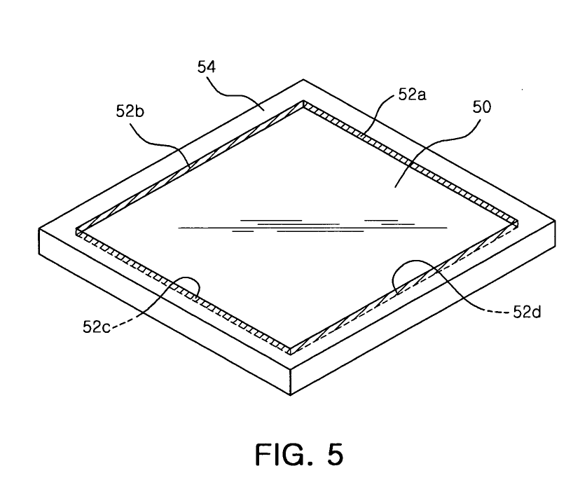

FIG. 5 is a schematic perspective view showing the display device of FIG. 4 according to another exemplary embodiment of the present invention.

Referring to FIG. 5, the display device may include a support frame 54 formed along edges of the region 50 of interest, and a reflecting surface reflecting light emitted from the apparatus (not shown) for detecting coordinates and an absorbing surface absorbing the emitted light may be respectively formed on inner side surfaces 54a, 54b, 54c, and 54d facing the region 50 of interest among side surfaces of the support frame 54, so that a reflectance of the emitted light from the apparatus (not shown) for detecting coordinates may be increased, or the light may be reflected only at the time of occurrence of the event (E) by absorbing the emitted light, and therefore errors generated when detecting coordinates of the event (E) by receiving the reflected light reflected by the event (E) may be suppressed.

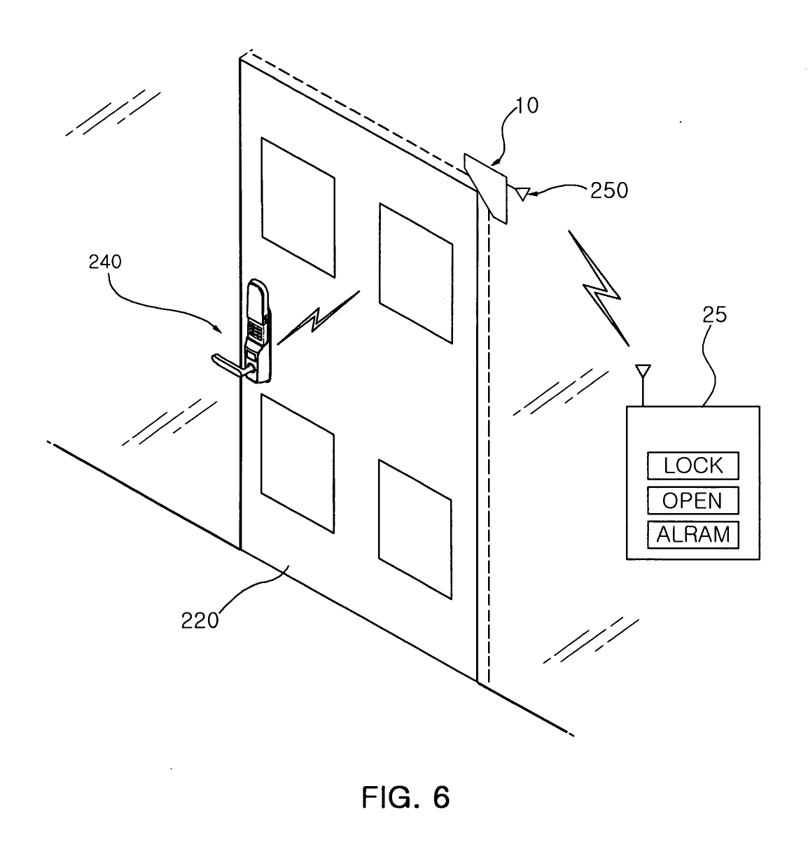

FIG. 6 is a schematic perspective view showing a security device to which an apparatus for detecting coordinates is applied according to an exemplary embodiment of the present invention.

Referring to FIG. 6, a security device 200 may include a door 220, an apparatus 10 for detecting coordinates, and a control unit 25.

The door 220 may be a region of interest of the apparatus 10. The apparatus may be installed to provide infrared light to the door 220. In this instance, the apparatus 10 may be installed on a side wall of the door 220.

Here, a condition in which a person conducts specific behavior within the region of interest, as well as a condition in which a person or an object is standing in front of the door 220, or passing by the door 220, may become an event. The apparatus 10 may recognize the event, and provide information about the detected event to the control unit 25. The control unit 25 may drive a door lock 240 depending on the event to open or close the door 220, or to make an alarm.

According to the present exemplary embodiment, the case in which wireless communication is performed between the apparatus 10 and a radio data transmitter 250 is illustrated; however, data transmission may be performed in a wired manner.

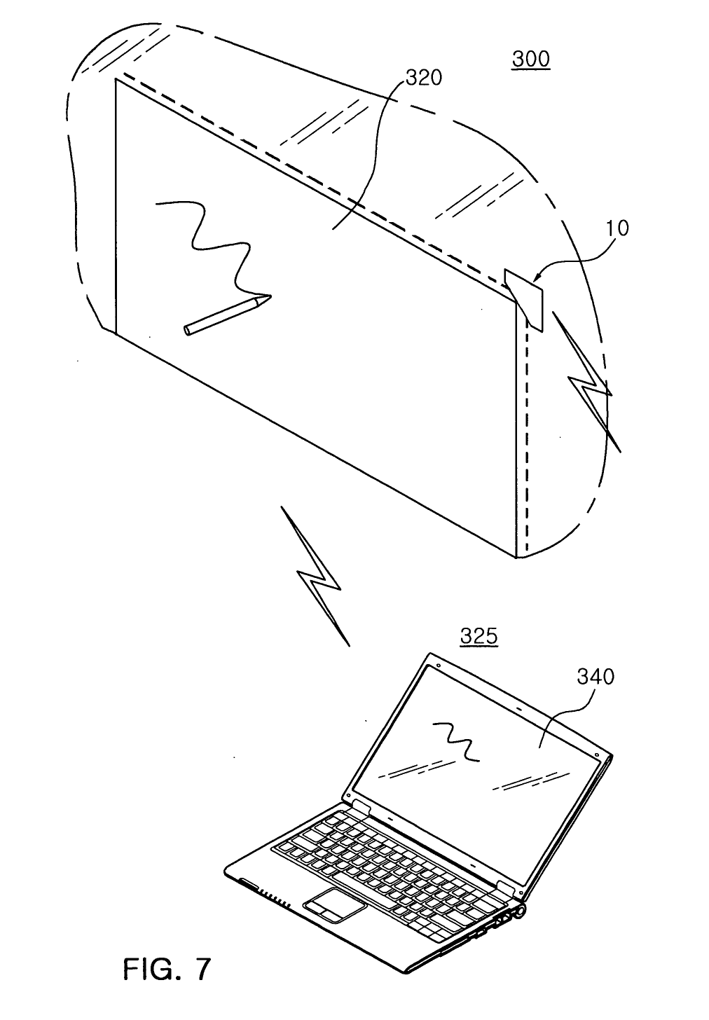

FIG. 7 is a schematic perspective view showing an electronic blackboard to which an apparatus for detecting coordinates according to an exemplary embodiment of the present invention is applied.

Referring to FIG. 7, the electronic blackboard 300 may include a board 320 and an apparatus 10 for detecting coordinates.

Here, the board 320 may be a region of interest of the apparatus 10. The board 320 may be a general wall, and any surface may be used as long as it is being used as a blackboard.

The apparatus 10 may be disposed at a side of the board 320 to recognize image information such as characters, printing, or the like made on the board 320.

Although not shown, the board 320 may have a support frame in the same manner as that of display device of FIG. 5, and a reflecting surface of an absorbing surface may be formed on an inner side surface of the support frame.

Data information stored in the apparatus 10 may be transmitted to a wiredly or wirelessly connected user information device 325 such as a notebook, a smart phone, or the like. The transmitted data may be displayed as an event (characters, printings, or the like) made on the board 320, through a display panel 340.

As set forth above, according to the apparatus for detecting coordinates, and the display device, the security device, and the electronic blackboard each including the apparatus, it may be possible to measure the coordinates of the event occurring within the region of interest using a single apparatus for detecting the coordinates thereof, thereby reducing an installation space of the apparatus, an installation time required for installing the apparatus, and the like.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for detecting coordinates, which is provided in at least one side of a touch panel having a preset region of interest being surrounded by a frame having a predetermined length, the apparatus comprising:
a light source body providing preset light;
a scanner emitting the light provided from the light source body at a preset angle to scan the region of interest, and receiving light reflected by the region of interest;
a photo diode receiving reflected light to convert the received reflected light to a voltage value; and
a beam splitter transmitting the light provided from the light source body to the scanner via a first path, and transmitting, to the photo diode via a second path, the reflected light received from the scanner.

2. The apparatus of claim 1, further comprising a control unit controlling the light source body to be emitted in a preset time unit, and calculating a location of an event occurring within the region of interest using a light emitting angle of the scanner and a time difference between emitted light and reflected and received light.

3. The apparatus of claim 2, further comprising a power supplying unit supplying, to the light source body, a pulse of power in the preset time unit based on a control of the control unit.

4. The apparatus of claim 3, further comprising a lens condensing the reflected light received from the beam splitter.

5. The apparatus of claim 2, wherein the scanner scans the region of interest by being rotated in a preset angle unit from a reference surface of the region of interest, based on a control of the control unit.

6. The apparatus of claim 1, wherein the light source body emits infrared light.

7. A display device, comprising:
a display panel being a region of interest;
a support frame supporting the display panel; and
an apparatus for detecting coordinates disposed in a side of the support frame, the apparatus including a light source body providing preset light to the display panel, a scanner emitting the light provided from the light source body at a preset angle to scan the region of interest of the display device and receiving light reflected by the region of interest, a beam splitter transmitting the light provided from the light source body to the scanner via a first path and transmitting, to a second path different from the first path, the reflected light received from the scanner, and a photo diode receiving the reflected light received from the beam splitter to convert the received reflected light to a voltage value.

8. The display device of claim 7, wherein the apparatus further includes a control unit controlling the light source body to be emitted in a preset time unit, and calculating a location of an event occurring within the region of interest using a light emitting angle of the scanner and a time difference between emitted light and reflected and received light.

9. The display device of claim 8, wherein the apparatus further includes a power supplying unit supplying, to the light source body, a pulse of power in the preset time unit based on a control of the control unit, and a lens condensing the reflected light received from the beam splitter.

10. The display device of claim 8, wherein the scanner scans the region of interest by being rotated in a preset angle unit from a reference surface of the region of interest, based on the control of the control unit.

11. The display device of claim 7, wherein the light source body emits infrared light.

12. The display device of claim 7, wherein the support frame includes an inner side surface formed along edges of the display panel, the inner side surface facing the display panel, and a reflecting surface reflecting light from the apparatus for detecting coordinates or an absorbing surface absorbing the light from the apparatus for detecting coordinates is formed in the inner side surface.

13. A security device, comprising:
an apparatus for detecting coordinates including a light source body providing preset light to a door being a region of interest, a scanner emitting the light provided from the light source body at a preset angle to scan the region of interest of the door and receiving light reflected by the region of interest, a beam splitter transmitting the light provided from the light source body to the scanner via a first path and transmitting, to a second path different from the first path, the reflected light received from the scanner, and a photo diode receiving the reflected light received from the beam splitter to convert the received reflected light to a voltage value; and
a control unit controlling opening and closing of the door by wiredly or wirelessly receiving event information obtained from the apparatus for detecting coordinates.

14. The security device of claim 13, wherein the control unit further controls the light source body to be emitted in a preset time unit, and calculates a location of an event occurring within the region of interest using a light emitting angle of the scanner and a time difference between emitted light and reflected and received light.

15. The security device of claim 14, wherein the apparatus for detecting coordinates further includes a power supplying unit supplying, to the light source body, a pulse of power in the preset time unit based on a control of the control unit, and a lens condensing the reflected light received from the beam splitter.

16. The security device of claim 14, wherein the scanner scans the region of interest by being rotated in a preset angle unit from a reference surface of the region of interest, based on the control of the control unit.

17. The security device of claim 13, wherein the light source body emits infrared light.

18. An electronic blackboard, comprising:
a display board being a region of interest and displaying a trajectory of an event occurring within the region of interest; and
an apparatus for detecting coordinates including a light source body providing preset light, a scanner emitting the light provided from the light source body at a preset angle to scan the region of interest of the display board and receiving reflected light by the region of interest, a beam splitter transmitting the light provided from the light source body to the scanner via a first path and transmitting, to a second path different from the first path, the reflected light received from the scanner, and a photo diode receiving the reflected light received from the beam splitter to convert the received reflected light to a voltage value, the apparatus for detecting coordinates detecting coordinates of a trajectory of an event occurring within the region of interest.

19. The electronic blackboard of claim 18, further comprising a control unit wiredly or wirelessly receiving information on the event of the apparatus for detecting coordinates.

20. The electronic blackboard of claim 19, wherein the control unit controls the light source body to be emitted in a preset time unit, and calculates a location of the event occurring within the region of interest using a light emitting angle of the scanner and a time difference between emitted light and reflected and received light.

21. The electronic blackboard of claim 20, wherein the apparatus for detecting coordinates further includes a power supplying unit supplying, to the light source body, a pulse of power in the preset time unit based on a control of the control unit, and a lens condensing the reflected light received from the beam splitter.

22. The electronic blackboard of claim 21, wherein the scanner scans the region of interest by being rotated in a preset angle unit from a reference surface of the region of interest, based on the control of the control unit.

23. The electronic blackboard of claim 18, wherein the light source body emits infrared light.

24. The electronic blackboard of claim 18, further comprising a support frame supporting the display board,
wherein the support frame includes an inner side surface formed along edges of the display board, the inner side surface facing the display board, and
a reflecting surface reflecting light provided from the apparatus for detecting coordinates or an absorbing surface absorbing the light provided from the apparatus for detecting coordinates is formed in the inner side surface.
